(19) United States
(12) Patent Application Publication
(10) Pub. No.: US 2011/0033772 A1
(43) Pub. Date: Feb. 10, 2011

(54) SINTERED POROUS STRUCTURE AND METHOD OF MAKING SAME

(75) Inventors: Michael C. Tucker, Berkeley, CA (US); Craig P. Jacobson, Moraga, CA (US); Steven J. Visco, Berkeley, CA (US)

Correspondence Address: Weaver Austin Villeneuve & Sampson LLP, P.O. BOX 70250, OAKLAND, CA, 94612-0250, US

(73) Assignee: The Regents of the University of California, Oakland, CA (US)

(21) Appl. No.: 12/809,455

(22) PCT Filed: Dec. 21, 2007
(86) PCT No.: PCT/US07/88703

§ 371 Date: Sep. 28, 2010

Related U.S. Application Data
(60) Provisional application No. 61/015,621, filed on Dec. 20, 2007.

(51) Int. Cl. C04B 35/64; B29C 45/00; H01M 8/10; B01D 39/20; B32B 3/26

(52) U.S. Cl. 429/479; 264/603; 264/413; 264/328.1; 210/510.1; 428/304.4

(57) ABSTRACT

Simple, low cost methods of manufacturing highly porous structures are provided. The methods involve building up porous structures with elements shaped to provide the desired strength, porosity and pore structure of the porous structure and then sintering the elements together to form the structure. Also provided are novel sintered porous structures made up of sintered non-spherical elements. In certain embodiments, the shaped green elements and the porous structure are simultaneously sintered. Also provided are novel sintered porous structures made up of sintered non-spherical elements.

### STATEMENT OF GOVERNMENTAL SUPPORT

This invention was made with government support under Contract No. DE-AC02-05CH11231 awarded by the United States Department of Energy to The Regents of the University of California for the management and operation of the Lawrence Berkeley National Laboratory. The government has certain rights in this invention

### BACKGROUND OF THE INVENTION

Porous structures are used in a wide range of applications from filtration to electrochemical devices. Solid-state electrochemical devices such as solid oxide fuel cells are made from layers that are porous and at least one layer that is dense. For example, the electrode layers (anode and cathode) are porous to allow fluid flow into and out of the porous layer while the electrolyte layer is a dense ion conductor that prevents gases from crossing over from one side to the other. Other layers can include a dense, electronically conductive interconnect layer and porous electrical contact layers between the dense interconnect and a porous electrode. One way to form a portion of or all of these multilayer structures is through cofiring. Cofiring is the sintering of the various layers at the same time. U.S. Pat. No. 6,605,316 describes the cofiring of a metal or cermet layer with an electrolyte layer such that the metal or cermet layer is porous after cofiring and the electrolyte layer is dense. The amount and type of porosity of the porous layer after sintering has an impact on the performance and the mechanical properties of the device. Alternatively the porous layer can be fired separately from the dense electrolyte layer and the layers assembled later. Forming highly porous structures by sintering can be a time consuming, expensive process.

Sintering is the thermal treatment of a material at a temperature of below its melting point, or in the case of a mixture, below the melting point of its main constituent. This typically increases the strength and densification of the material. Sintering is used to make objects from powder, by heating the powder below its melting point until its particles bond to each other.

Sintered porous structures are conventionally made from sinterable metal, ceramic, or glass powders with the addition of pore formers in the form of polymers, particulates, liquids, and/or gases. Pore formers are removed by a variety of methods and the powder sintered to obtain a strong porous structure. Often it is the pore forming means that makes manufacturing porous structures an expensive, time consuming process. For example, the use of pore formers that dissolve, decompose or burn out is well known. The difficulty with burning out pore formers is that the high porosity needed leads to a low green strength material. When cofiring multilayer structures such as solid oxide fuel cells, for example, having a low green strength material makes it difficult to handle and or apply subsequent layers such as electrodes/electrolytes. In addition, the large volume fraction of pore former needed makes removal of the pore former time consuming and potentially a source of pollution.

Extractable particulates such as NaCl or KCl have been used in the processing of porous metal, with the particulates removed prior to or after sintering. However, the removal of the salts can be costly and contamination by the alkali elements a concern.

Porous structures may also be made by the replica method, in which a porous polymer foam is impregnated with a ceramic material, thereby forming a negative replica of the porous polymer foam. Drying and calcining steps are then used to remove the polymer and cause the ceramic material to sinter. This method requires multiple time consuming infiltration and drying steps. In addition, the decomposition of the polymer can result in toxic gases and results in open pored, spongy foam with low densities and low strengths because of defects resulting from polymer removal. This method is also limited to fine powders since large particles will not adhere to the porous foams.

Another method to form porous structures is the bubble-forming technique. This technique is based on producing and stabilizing bubbles within the liquid mass. The bubbles are produced by physical or chemical processes resulting in gaseous components, including steam. This method can involve dangerous chemicals and often cannot be applied to high melting point ceramics and metals.

Freeze casting has also been employed. However this method is slow and requires expensive processing equipment. Wires and flakes can be sintered bonded to form highly porous structures. The wires or flakes bond at the contact points with little shrinkage during processing. However this method is not suitable for forming multilayered structures due to the differences in sintering as described below.

### SUMMARY OF THE INVENTION

Simple, low cost methods of manufacturing highly porous structures are provided. The methods involve building up porous structures with elements shaped to provide the desired strength, porosity and pore structure of the porous structure and then sintering the elements together to form the structure. Also provided are novel sintered porous structures made up of sintered non-spherical elements.

One aspect of the invention relates to a method of fabricating a porous network involving providing a plurality of green non-spherical elements, each of which is made up of particles (e.g., powder); arranging the non-spherical elements in a desired shape of the porous network to form a green porous body; and simultaneously sintering the particles together to form sintered non-spherical elements and sintering the non-spherical elements together to form the porous network. Examples of non-spherical elements include stellated-shaped elements, linear, bent or coiled strand elements, spiral elements, brick-shaped elements, ring-shaped elements, tubular elements, torroidal elements, saddle-shaped elements, disks, sheets, woven elements and jack-shaped elements. In certain embodiments, the formed green body has low green density, e.g., less than 30-45% (as required for low sintered density), while still having sufficient mechanical strength to support additional layers.

Also provided is a method of fabricating a planar thin sheet porous network, involving providing a plurality of green non-spherical elements; arranging the plurality of non-spherical elements in a plane having first and second major faces to form a green porous body; and sintering the plurality of non-spherical elements together to fabricate the planar thin sheet porous network. In certain embodiments, the non-spherical elements are composed of particles, which may be sintered simultaneously with the green elements.

Another aspect of the invention relates to a porous network of sintered-together non-spherical elements, each non-spherical element composed of a plurality of sintered-together particles.

In certain embodiments, the network is planar and/or defines a plurality of flow paths between major surfaces of the network. According to various embodiments, the network has a high connected porosity, e.g., at least 40%, 60% or 90%. Also provided is a structure of a planar porous network of sintered-together non-spherical elements, having first and second major surfaces; said porous network defining a plurality of flow paths from the first major surface to the second major surface; wherein the size of said elements ranges from 5 microns to 5 centimeters, and wherein the network has a connected porosity of at least 30%.

Other aspects of the invention relate to solid state electrochemical device structures including substrates of sintered non-spherical elements and thin sheet fluid filtration device structures including sintered networks of non-spherical elements, and methods of preparing these structures.

These and other features and advantages of the present invention will be described in more detail below with reference to the associated drawings.

### BRIEF DESCRIPTION OF THE DRAWINGS

FIG. 1 is a process flow chart depicting stages of a process of producing a sintered porous structure in accordance with various embodiments of the present invention.

FIG. 2 illustrates operations in a process of producing a sintered porous structure in accordance with various embodiments of the invention.

FIG. 3 is a process flow chart depicting stages of a process of fabricating shaped non-spherical elements to be used as building blocks of the porous structures according to certain embodiments of the present invention.

FIG. 4 is a process flow chart depicting stages of a process of producing a sintered porous structure in accordance with various embodiments of the present invention.

FIG. 5 depicts examples of distillation-type packings that have low random packing densities.

FIG. 6 depicts schematics of (a) randomly packed spheres and (b) randomly packed annular rings.

FIG. 7a is a schematic depicting sintered-together spheres.

FIG. 7b is a schematic depicting a portion of a structure of sintered-together spherical particles and a portion of a thin film porous support structure of sintered-together dense bars of uniform cross-section.

FIG. 7c is a schematic depicting a cross-sectional portion of a support structure made up of brick-shaped elements.

FIG. 8 shows cross-sectional diagrams of sections of two porous sheets: one with pores oriented perpendicular to the plane of the film and one with pores oriented parallel to the plane of the film.

FIGS. 9a and 9b show examples of non-spherical elements and ordered porous structure arrangements.

FIG. 9c is a schematic depicting cross-sections of a porous structure having a bimodal pore distribution and of a porous structure having a graded pore distribution.

FIG. 10a illustrates operations in a process of producing a porous structure from elongated elements according to certain embodiments of the present invention.

FIG. 10b illustrates operations in a process of producing a porous structure using a fugitive pore former to influence packing arrangement according to certain embodiments of the present invention.

FIG. 10c illustrates operations in a process of producing a porous structure having a wall according to certain embodiments of the present invention.

FIG. 11a shows a cross-section of planar porous structure according to various embodiments of the present invention.

FIG. 11b depicts a planar design for a solid state electrochemical device.

FIG. 12a is an image of a sintered porous stainless steel bed formed according to an embodiment of the present invention.

FIG. 12b is an image of a sintered porous ceramic bed formed according to an embodiment of the present invention.

### DETAILED DESCRIPTION OF PREFERRED EMBODIMENTS

### Introduction and Relevant Terminology

The present invention relates to sintered porous structures and methods of producing them. It provides novel, efficient and low-cost methods of forming strong porous structures, as well as novel porous structures. Porous metal, ceramic, cermet, and polymer structures have many applications including as supports for catalyst deposition, porous support structures for electrochemical devices such as solid oxide fuel cells or electrochemical pumps, support structures for porous or dense membranes for gas separation or filtration, as filters for hot gas and liquid filtration, porous contact layers for electrochemical devices, and as low density insulating materials that insulate against sound or heat.

While there are many methods of making porous structures, forming multilayer structures imposes additional constraints. When multilayered structures are formed the differences in the sintering properties of the various layers can result in warping or cracking of the layers. This is especially difficult with multilayer structures wherein after processing at least one layer requires low density, high connected porosity, high permeability, and sufficient mechanical strength to support the other layers and a second layer requires high density. In conventional powder processing the green density ranges from about 40-65% of the theoretical density. During sintering to high density, for example >95% density, as is required for gas tight electrolytes, the percent linear shrinkage then ranges from about 12-25%. To obtain porous layers with about 30 vol. % porosity (70% density), as is required for porous electrode layers, the starting or green density of the porous layer should range from at most about 30-45% of the theoretical density. With conventional powder processing it is very difficult to get green bodies having a green density less than 30%, which is needed to obtain sintered density of less than 70%. Moreover, these conventional highly porous green bodies lack the mechanical strength to support the other layers.

It is often preferred to have sintered structures with final connected porosity much greater than 30 vol. %. The methods of the invention provide a simple, low cost method to form green porous layers with less than 30-45 vol. % of theoretical densities that have well controlled shrinkage, high connected porosity, and result in strong sintered bodies. The green porous layers have the necessary low green densities (high porosities) to obtain the high connected porosities, and provide a strong mechanical support for other layers.

The methods of the present invention involve sintering together shaped sinterable elements to form a porous structure or network. Sintering is the thermal treatment of a structure or material that densifies the structure or material by heating it to below its melting point. A sintered structure may be made from sintering building blocks, e.g., particles or elements, of the structure until they bond to each other. The term “sintered-together elements” refers to elements that are bonded to each other by sintering. Similarly the term “sintered-together particles” refers to particles that are bonded to each other by sintering. According to certain embodiments, the porous networks are made of sintered-together elements, which in turn may be made of sintered-together particles.

Sintered porous structures are conventionally made by adding pore formers to sinterable metal, polymer, glass or ceramic powders. Pore formers may take the form of polymers, particulates, liquids and/or gases. The pore formers are removed by a variety of methods and the powder then sintered to obtain a strong porous structure. Manufacturing porous structures in this manner can be an expensive, time consuming process due to incorporation, handling and removal of the pore formers. Conventional sintered structures are sponge-like, i.e., having fairly uniformly sized pores distributed uniformly throughout the material, and with void spaces similar in size to the sintered particles.

In the methods described herein, the elements are shaped to give the porous structure the desired characteristics—in general a highly porous, strong structure. The character of the connected porosity—shape, size and distribution—is determined by both the shape and the arrangement of the elements. By appropriately shaping and arranging the elements, the degree of flexibility in pore size, shape and distribution is significantly greater than in conventional methods. In addition, the methods are simple to implement and provide low cost manufacturing of porous structures.

While much of the description below is presented in terms of thin sheets of porous structures or networks and methods of making thin film porous structures, the invention is by no means so limited. In general, the methods and structures are applicable to any application in which porous structures are used and may be formed for that application using an appropriate mold or die. For example, in certain embodiments, the porous structures form cup-shaped, block-shaped, or conical filters. In the following description, numerous specific details are set forth in order to provide a thorough understanding of the present invention. It will be apparent, however, that the present invention may be practiced without limitation to some of the specific details presented herein.

The following terms are used throughout the specification. The descriptions are provided to assist in understanding the specification, but do not necessarily limit the scope of the invention.

Elements are the building blocks of the sintered porous structure. In general, the elements used in the methods described herein are non-spherical. The elements themselves are typically made up of smaller, high surface area particles, e.g., pressed powder. Elements are typically in the range of 5 μm-5 cm and are made up of particles having a size between 0.1-100 μm.

Porosity is the percentage of bulk volume of a structure that is occupied by void space, i.e., the ratio of pore volume to total volume of a structure. Total porosity is made up of isolated and connected porosity. Connected porosity refers to void space that is connected to the outside of the structure. In the case of porous networks such as those described herein, all or most of the voids between elements are connected. The elements themselves may be dense or contain isolated and/or connected pores. In most cases, if the elements themselves are porous, these are micropores and make up a minor contribution to the total or connected porosity of the porous network. In some applications, however, bimodal pore size distributions (e.g., larger inter-element pores and smaller intra-element pores) are useful.

Packing density is the percentage of bulk volume of a network filled by packed together solid particles or elements. Packing densities of networks depend in part on the manner in which the solids are packed together as well as the shape of the solid particles or elements. Maximum packing density results from highly ordered packing while random packing results in lower packing densities. The maximum packing density of identical spheres is 74%, achieved when spheres are packed in a face-centered cubic (fcc) lattice. Packing density of randomly packed structures depends in part on how the solids are packed, e.g., by shaking, stirring, feeding, etc. Randomly packed spheres have a packing density ranging from about 64%-68%, depending on the manner of packing. As described further below, embodiments use non-spherical elements having lower packing densities than can be achieved with spherical particles. Flat disks, for example, have been shown to have a packing density of about 54% and packing of the type used in distillation columns as low as 2%. A broad element or particle size distribution tends to increase packing density because smaller particles can be packed into void spaces created by larger particles.

Green density is the density of an unsintered (green) material. In the methods described herein, non-spherical elements are arranged to build up a green porous structure, which is then fired to sinter the elements together producing a sintered porous structure. As used herein, the green density of the porous structure is the density of the elements as packed together—i.e., the packing density. After sintering, the porous structure has a connected porosity through which fluid may flow. The connected porosity depends on the green density and amount of shrinkage during sintering. For example, a porous structure having a green density of 45% may have a sintered density of 55%, and thus a connected porosity of 45%. The green density or packing density of the structure is low enough so that after shrinking and densification of sintering, the connected porosity of the structure is as desired. It is possible that within each element there is also has a green density, e.g., if the element is made of or includes a green powder compact, which can then be fired to form a sintered element. This intra-element green density is independent of the green density of the overall porous structure. In certain embodiments, the elements have a green density of at least 40% to drive the sintering together of the elements that form the structure. After sintering, the elements may be dense or may retain some degree of porosity.

### Producing a Porous Structure

As described above, existing methods of providing porous structures suffer from various drawbacks, including the challenges of dealing with and removing pore formers from the structures and of tailoring the characteristics of the porous structure. The methods of the present invention involve preparing elements shaped to provide a desired porous structure and sintering those elements together to form the porous structure. The methods produce sintered structures having porosities previously obtainable only by using pore formers or replica methods to provide the main void space.

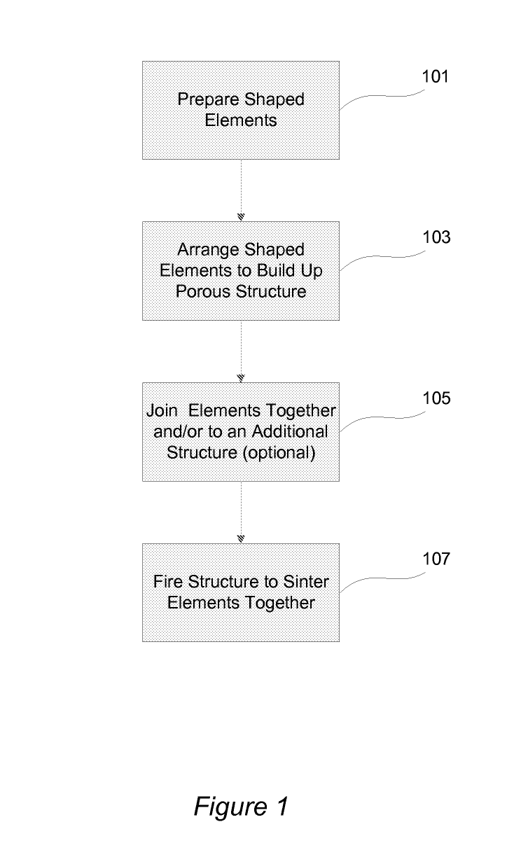

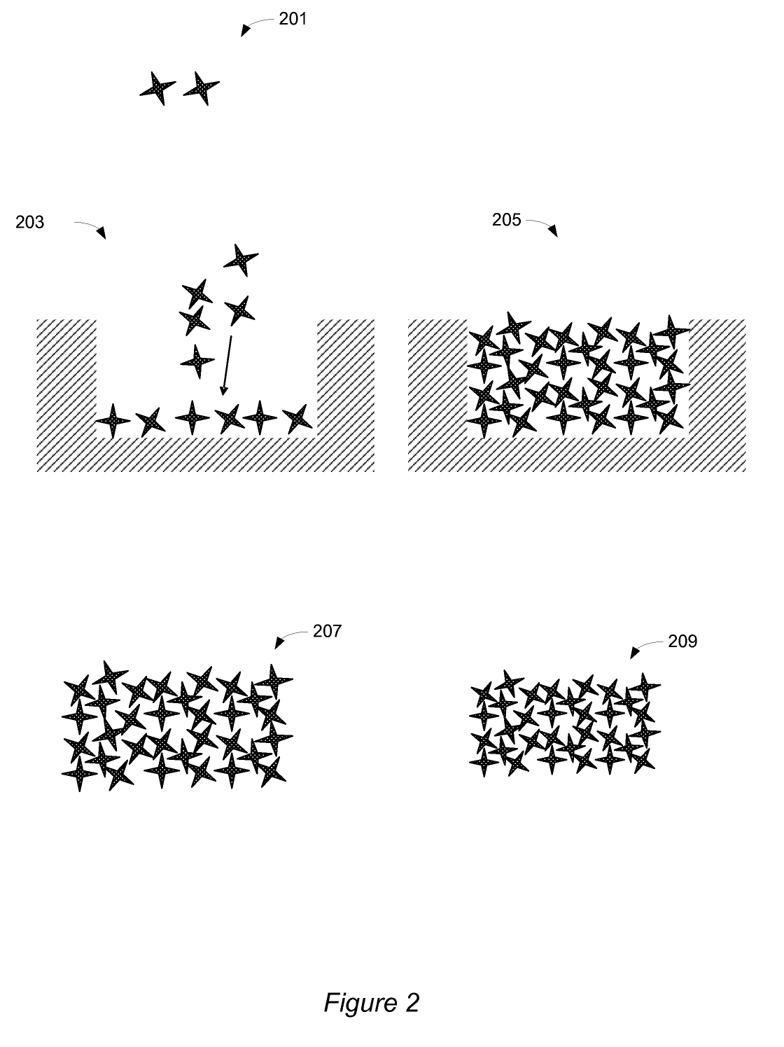

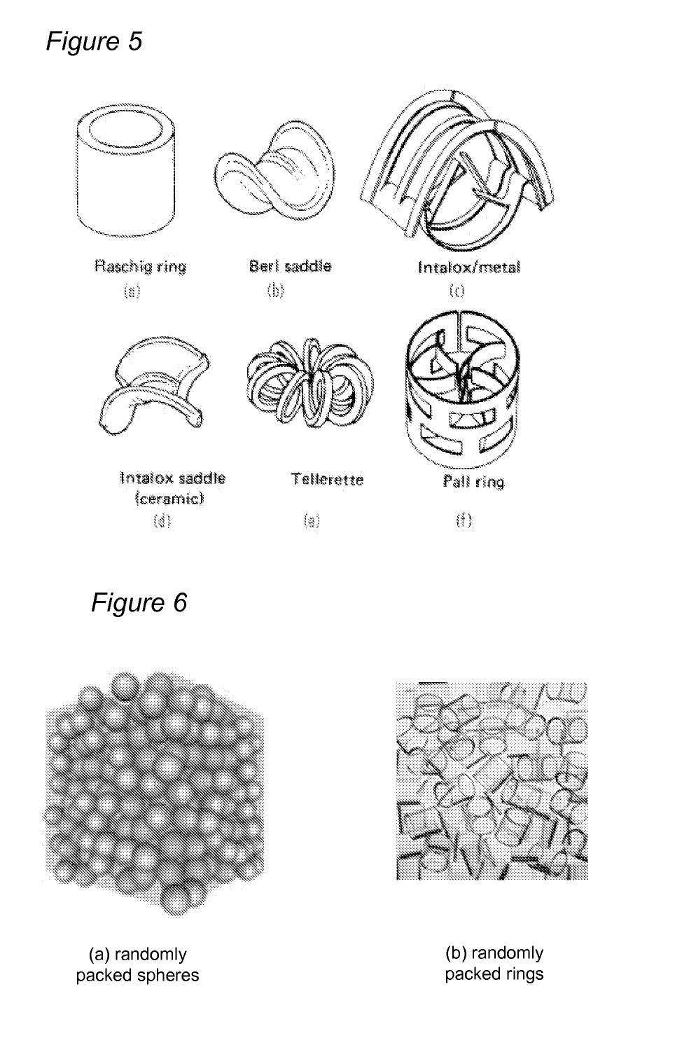

FIGS. 1-4 give an overview of the process used to form the structures, with further details elaborated on below with reference to FIGS. 5-11b. FIG. 1 is a process flow sheet showing an overview of the process of producing a porous structure. The process begins with preparing shaped elements (101). The elements are shaped to obtain the desired packing density, strength and porosity of the final porous structure. In many embodiments, the elements are shaped to have low packing densities. Appropriate shapes are discussed further below, with examples including stellated (star) shapes, coiled shapes, torroids, brick-shapes, rings, tubes, disks and saddles. Element shapes do not have to be identical; a porous structure may include multiple different types of shapes, e.g., tubes and saddles. Element size depends on the particular application, but is typically in the range of 5 μm-5 cm. Element size distribution typically has only one peak (is unimodal) and narrow—in part because, as explained above, having a broad range of size distribution can result in higher packing densities. In certain embodiments, however, broad or multi-modal size distributions are used, e.g., for graded porous structures. Elements may be made of any material that may be sintered, including but not limited to, metal, ceramic, polymer, glass, zeolites, etc. As described further below, in certain embodiments, the elements contain additives that may be burnt off during the sintering process. FIG. 2 is a graphical depiction of one example of forming a porous structure. In the example in FIG. 2, stellated-shaped elements are prepared at 201. Preparation of the shaped elements is also described further below, but in general the elements may be prepared by any appropriate method including tape casting and cutting, extrusion, injection molding, pressing, etc.

Returning to FIG. 1, once the elements are prepared, they are arranged to build up the porous structure or network in an operation 103. In certain embodiments, a die or mold is used to define the boundaries of the porous structure. The elements may be placed, shaken, fed, etc. into the die or mold. FIG. 2 shows a die for a planar porous network partially filled with the stellated elements at 203. The assembled structure is shown at 205. According to various embodiments, assembling the structure may involve random, semi-random, or ordered packing, introducing other components of the structure such as reinforcing bars, and the like. At this point, the basic form of the skeleton of the porous structure is in place, though at a larger dimension than the final porous structure. As discussed further below, various additives may be incorporated into the material of the individual elements, used to coat or otherwise added to each element or the assembled structure to facilitate subsequent joining and/or sintering operations.

After the elements are arranged, the elements are optionally joined in an operation 105. Joining the elements prior to sintering them together may be done to interlock the elements, improve handling strength and/or connect the elements to an additional layer, such as an electrode or electrolyte layer. After this operation, each element may be chemically or mechanically bonded to the abutting elements and/or to a separate layer. Depending on the element material, this operation may employ one or more of bisque firing, compression, thermal treatment, soaking in a solvent, wash coating with binder and/or particles, exposure to light or ultrasound, or other known methods to join the elements together and/or to one or more additional layers. This operation may provide mechanical integrity to the material for handling, but does not produce any substantial dimensional change as sintering does. The stellated elements in FIG. 2 are shown joined together at 207. Also, at or after this operation, the die or mold may be removed as shown at 207.

Returning to FIG. 1, after the porous structure is built up and, if performed, the elements are joined together, the structure is fired to sinter the elements together in an operation 107. Sintering is a process of forming a coherent mass by heating without melting. The resulting structure is shrunk and densified. The amount of shrinkage depends on the material, firing time and temperature, etc. Fired density, and thus the amount of connected porosity, correlates with the green density of the structure. According to various embodiments, the sintered porous structure will have a connected porosity of at least 30%, 40%, 50%, 60%, 70%, 80%, or 90%. The desired connected porosity is achieved by appropriately selecting the element shapes and arranging the porous structure. If the structure contains additives (binders, pore formers, etc.), these are also typically removed by firing. Once the structure is sintered, it may be further processed or put into use. Further processing may include coating it with a catalytic material, fitting it into a device, etc.

In certain embodiments, preparing a shaped element involves shaping or forming a shaped green powder compact, and then firing the compact to produce a sintered element.

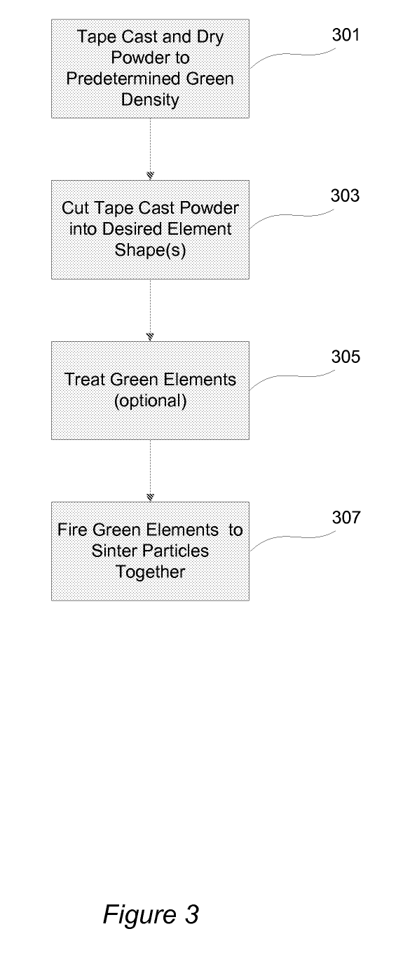

FIG. 3 is a process flow sheet that shows one example of forming the element by sintering a green powder compact. In the example shown in FIG. 3, a powder is tape cast and dried to a predetermined green density in an operation 301. Tape casting is a process typically used for creating large, thin and flat ceramic or metallic parts. The cast and dried powder is then cut into the desired shape—for example, into strips, disks, etc., in an operation 303, to form shaped green elements. The green elements are optionally treated in an operation 305, e.g., by bisque firing, soaking in a solvent, etc. Each green element is fired to sinter it and form a shaped sintered element in an operation 307. Tape casting and cutting is just an example of a method of forming a shaped green element. Regardless of the method of forming the shaped green elements, the green elements are fired to form the sintered elements.

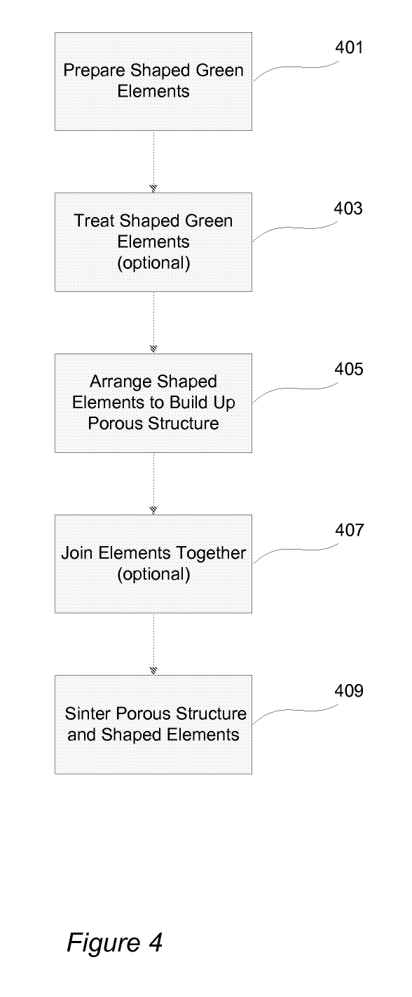

In certain embodiments in which the elements are formed by sintering such as in the process of FIG. 3, the porous structure and green elements may be simultaneously sintered wherein the particles that make up each element and the elements that make up the porous structure are sintered together. FIG. 4 is a process flow sheet showing an embodiment of the method discussed above with reference to FIG. 1, in which the green elements and porous structure are sintered together.

First, the shaped green elements are prepared in an operation 401. This may be done by tape casting and cutting, extrusion, injection molding, die pressing, etc. An optional treatment step, e.g., to improve handling strength during the subsequent shaking, gravity feed, etc., may be performed in an operation 403. Bisque firing, thermal treatments, exposure to light or ultrasound are examples of treatments. The green elements are then arranged as discussed above with regard to FIG. 1 in an operation 405. The green elements are then optionally joined together an as discussed above in an operation 407. The porous structure and the elements are sintered in an operation 409. The result is simultaneously sintering together the particles or powder of each green element to form sintered elements, and sintering the elements together to form the sintered porous structure or network.

### Element Shape

The porous structures are formed by sintering together elements shaped so as to provide the desired pore structure after sintering. These elements are non-spherical and according to various embodiments, are shaped to provide the porous structure with some or all other following characteristics: high porosity, high strength, having pores aligned with the direction of gas flow (perpendicular to the plane of the film), and having an average or median pore size significantly larger than the average or median particle size.

A non-exclusive list of element types that may be used in the methods of the invention includes stellated shapes, rosette-shaped elements, linear, bent or coiled strands, spiral elements, spring-shaped elements, brick-shaped elements, ring-shaped elements, tubular elements, torroidal elements, saddle-shaped elements, helical elements, disks, sheets, woven elements, arcuate elements, elongated elements, non-spherical solids (e.g., polyhedra), jack-shaped elements, Mobius strips, elements resembling: pasta, noodles, birdcages, steel wool, woven mats, felt, packing peanuts, expanded metal mesh, chicken wire, waffle-cut or julienned vegetables, metal turnings and snowflakes. The elements may be symmetric or asymmetric. The elements may have straight or curved projections. Elements with radiations, e.g., stellated, rosette-shaped and jack-shaped, elements, may have shorter or longer radiations. An element may have a single radiation, or multiple radiations like a star. Radiations may be in two or three dimensions. Curved elements include arcuate, arrowhead, horseshoe-shaped elements. Solid shapes include platonic and Archimedean solids, e.g., polyhedra, truncated polyhedra, multiple polyhedral shapes, etc. Any of these may be mixed to create the desired pattern of voids.

Elongated elements may be linear, bent, curved, spiraled or coiled. Strands may be the same length or have differing sizes. In the case of stranded repeat units, the strands may be woven, matted, felted, mixed, etc with strands or other shapes to create a regular or irregular pattern of voids in the final sintered body. The stranded elements may be spirally wound, coiled, or nested. Spiral elements include cylindrical and conical spirals.

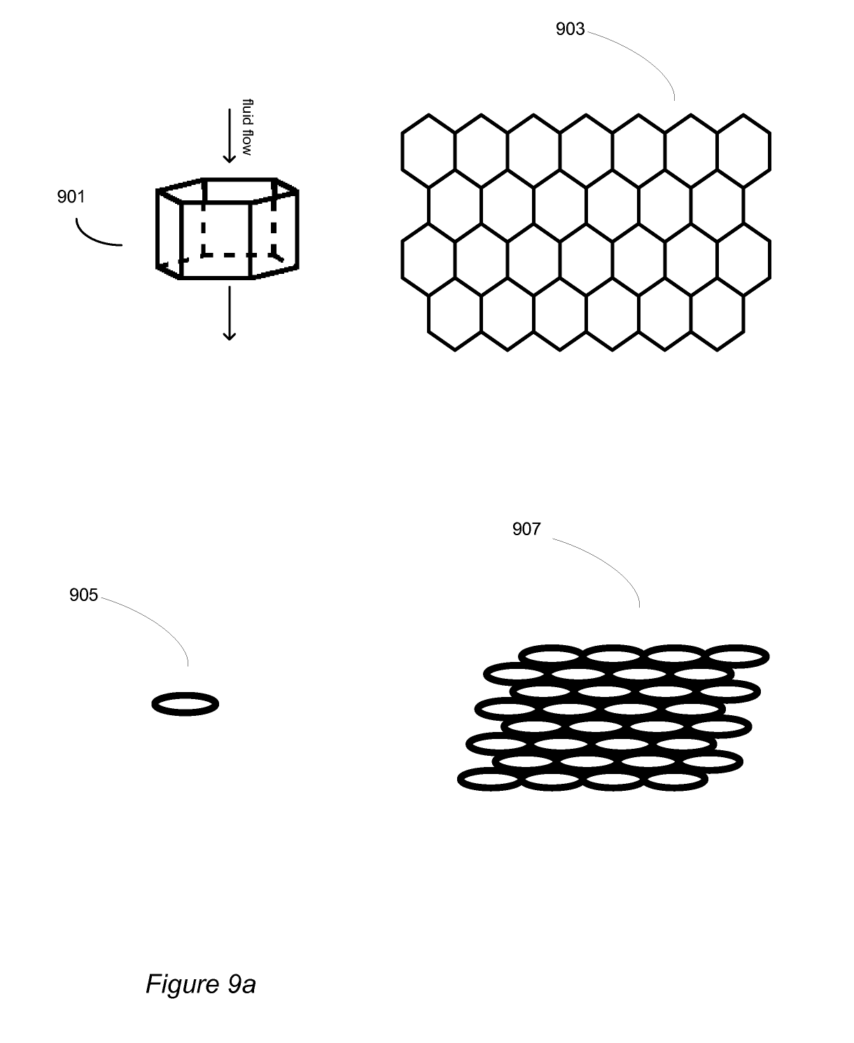

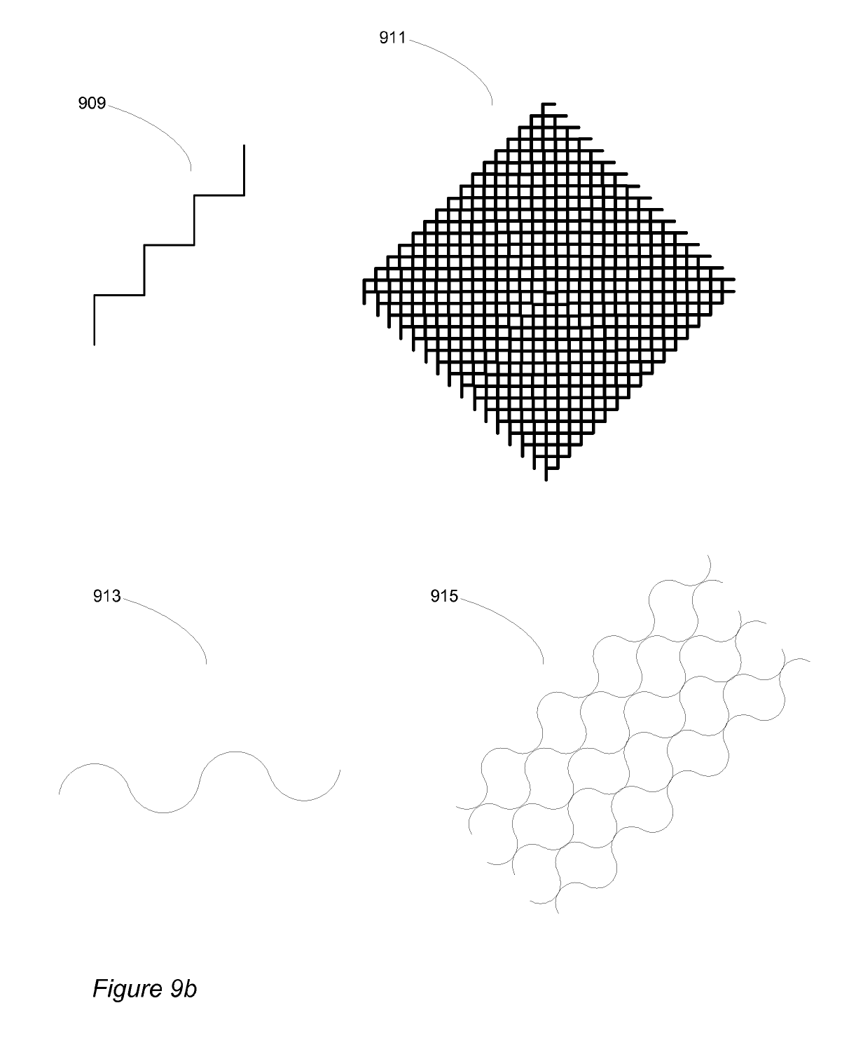

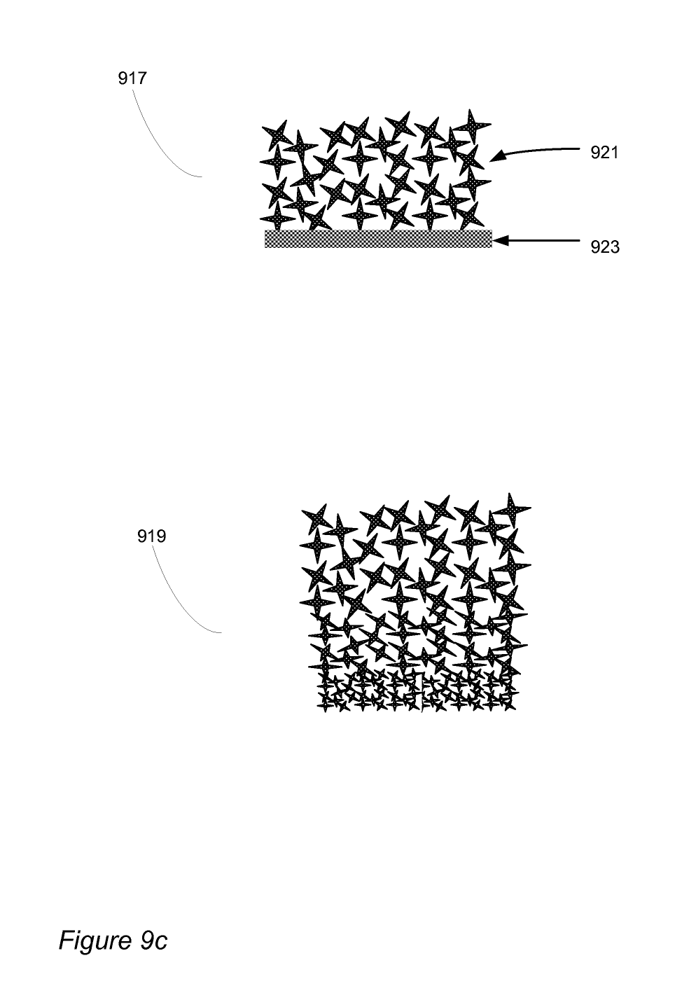

In certain embodiments, the non-spherical elements are tubular or annular, i.e., open ended on two opposing sides. Examples are rings, torroids, Raschig® rings (FIG. 5), Pall® rings, and honeycomb-forming elements (FIG. 9), etc. In certain embodiments, the non-spherical elements have a saddle-shape. Berl® saddles and Intalox® saddles (FIG. 5) are specific examples. Elements may also contain two or more of these features, for example, Intalox® rings shown in FIG. 5 are annular with curved inward projections. Elements may have flat, concave, and convex (non-spherical) surfaces. In certain embodiments, elements have two or more of types of these surfaces, e.g., convex and concave (saddles, tubular elements).

As described above, the elements are shaped to provide the porous network with various desired characteristics. In many embodiments, low packing densities are desirable to form highly porous structures. To this end, non-spherical elements are used. As discussed briefly above, packed spheres in a face centered cubic or hexagonal close packed arrangement have a packing density of 74%. Other ordered spherical packing arrangements have slightly lower packing densities, including about 68% in a body centered cubic arrangement. Random packing of spheres can result in packing densities only as low as about 64%-68%.

According to various embodiments, the packing density of the porous structure is at most about 70%, 65%, 60%, 55%, 45%, 40%, 35%, 30%, 25%, 20%, 15%, 10%, 5%, or 2%. Packings of the type used for distillation columns, for example, have very low packing densities. FIG. 5 shows examples of shapes used in distillation columns: (a) Raschig® rings, (b) Berl® saddles, (c) Intalox® rings, (d) Intalox® saddles, (e) Tellerettes®, and (f) Pall® rings. As indicated, random packing densities of these packings are low—Raschig® rings have reported random packing densities ranging from 3%-38%, Berl® saddles from 30-40%, Intalox® rings as low as 2-3%, Intalox® saddles as low as 7%, Tellerettes® as low as 7%, and Pall® rings as low as 3-10% (Perry's Chemical Engineers' Handbook, Seventh Edition). Other random packings include Cascade mini-rings, Nutter rings, VSP, Tri-Pack rings, etc., which have random packing densities as low as about 2%.

For comparison, spheres, as indicated above, have a random packing density of at least about 64%. FIG. 6 shows renderings of random arrangements of (a) spheres and (b) Raschig® rings. As can be seen from the figure, a porous structure formed of sintered Raschig® rings, or similarly annular shaped elements, has a much higher porosity than that of sintered spheres. The elements may be designed to be placed into the die or mold in a random arrangement—such as the annular rings in FIG. 6, designed to be placed in a non-random irregular or regular arrangement, and/or to shaped to fit the mold dimensions.

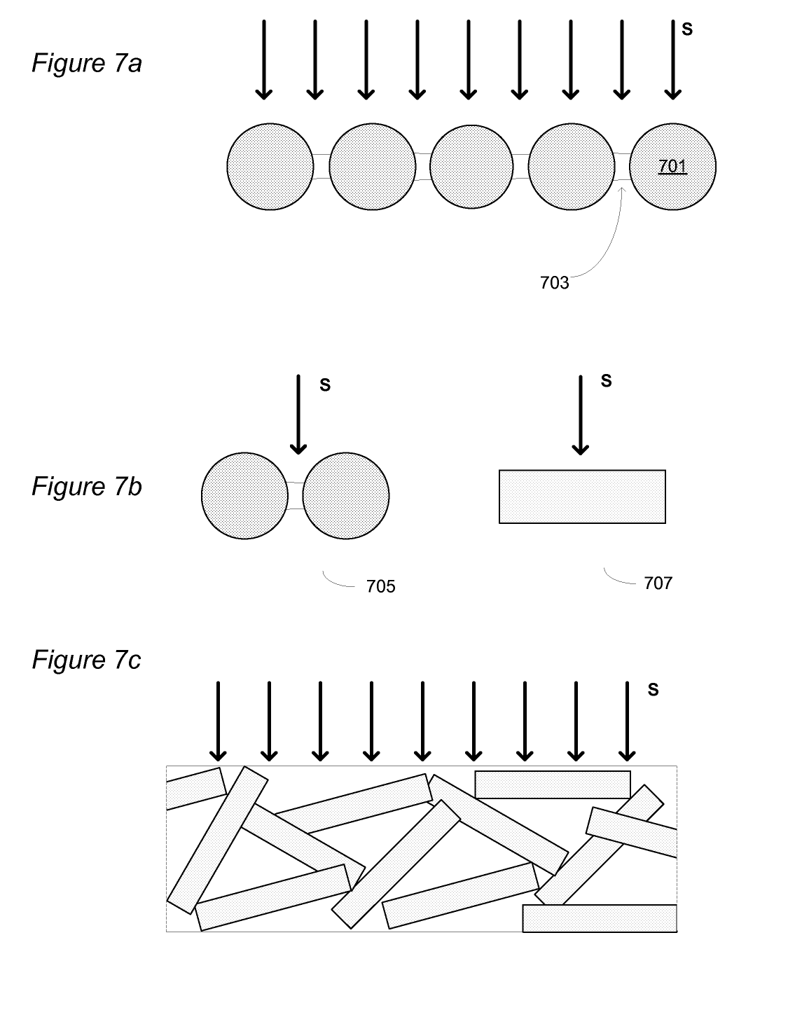

Another feature of the particles according to certain embodiments is the strength of the porous structures. In applications in which the porous structure is a support for a solid oxide fuel cell, for example, the structure is strong enough to support the stacked electrolyte and electrode layers. Strength of sintered networks of spherical elements depends on the inter-particle neck size. FIG. 7a shows a schematic depicting a portion of a porous support structure of sintered spheres. Spherical particles (701) are sintered forming necks (703) that bind the particles together. Arrows indicate stress on the structure, e.g., from a solid oxide fuel cell electrolyte or flowing fluid. The neck limits the strength and mechanical properties of the porous structure.

In certain embodiments, the shape of the elements is chosen to have a strength controlled by the elements that make up the structure, rather than the necks that form between them. As an example, FIG. 7b shows a portion 705 of a structure of sintered-together spherical particles, with the strength as controlled by the neck. For comparison, portion 707 of a porous support structure of dense bars has a uniform cross-section. Because the cross-sectional area is uniform, the structure has a strength controlled not by neck thickness but by the thickness of the bar. FIG. 7c shows a schematic depicting a cross-sectional portion of a support structure made of brick-shaped elements. Note that the brick-shaped elements are able to contact and be sintered to other elements at much lower packing densities than spheres. Sintering at these contact points increases strength, and in addition to being stronger, the structure provides much higher porosity than one made up of packed spheres.

Low packing density and higher strength are not limited to the non-spherical elements shown in FIGS. 5-7. Spherical packing density is high in part because surface area to volume of a sphere is low—spheres have the lowest surface area among all surfaces enclosing a given volume. Non-spherical elements have higher surface area to volume ratios and thus a larger amount of surface available for bonding. Elements with rough surfaces or protrusions also provide the opportunity for mechanical interlocking between elements. The result is both green and sintered structures of a given volume may have greater porosity and strength if built of rough or non-spherical elements than built of spherical elements.

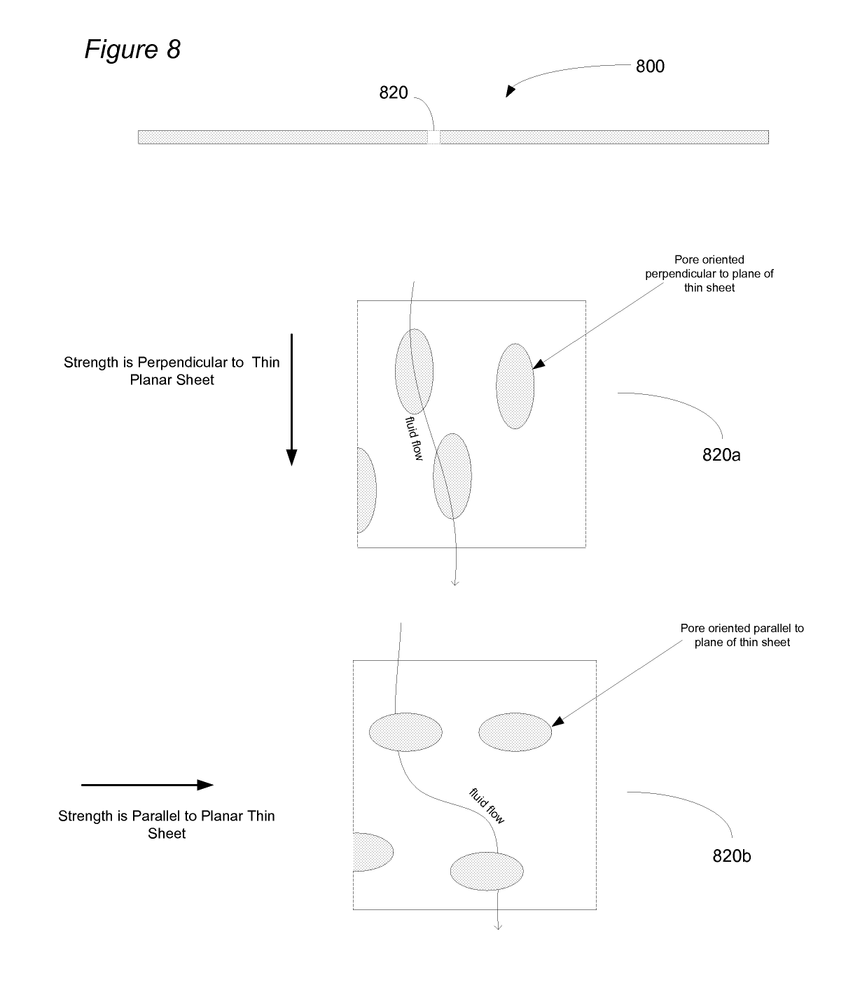

Another manner in which characteristics of the porous structure may be controlled is the shape and orientation of the pores. In thin sheet embodiments, gas flow is generally transverse to the plane of the porous structure. FIG. 8 shows a small section 820 of a planar porous thin sheet structure 800. Cross-sectional diagrams of two possible pore structures are shown in blown-up views 820a and 820b of section 820: view 820a has pores oriented perpendicular to the plane of the thin sheet and aligned with the direction of gas flow and view 820b has pores oriented parallel to the plane of the sheet. The porous structure shown in 820a has strength perpendicular to the plane of the film or sheet, e.g., to support a fuel cell or filtration device, while the orientation of the pores in 820b gives it strength in the direction parallel to the sheet. Generally having pores aligned perpendicular to the plane of a thin porous planar sheet provides greater strength than unaligned pores or pores aligned parallel to the sheet. Element shape may also be chosen to achieve desired gas flow characteristics. The structure shown in 820a, for example, provides less resistance to gas flow. In certain embodiments, shapes are chosen to provide highly tortuous gas flow paths. (The arrows represent fluid flow through interconnected pores, though because FIG. 8 is a cross-sectional representation, the passageways between pores are not apparent from the figure).

Elements may also be shaped to control the shape and size of the pores. In general, structure pore volume is significantly greater than the pore volume of the individual elements (intra-element pore volume). This is unlike sintered homogeneous powder in which the pores and particles are in the same size range.

In certain embodiments, the elements are shaped for highly ordered packing. FIG. 9a shows examples of two such embodiments. In one embodiment, the axial ends of hexagonal element 901 are open to allow flow in the direction indicated. The hexagonal elements are arranged to form a honeycomb structure (903). The elements are placed in an ordered fashion to build a bed of elements, and may be placed as a single layer or multiple layers. The sintered honeycomb structure is strong and provides low-resistance flow paths. In one example, the sintered structure is bonded to an electrolyte or electrode layer in an electrochemical device. The sintered honeycomb structure mechanically supports the layer and allows large areas of access to the sheet, e.g., to allow passage of electrochemical reactants. Multiple layers may be stacked to provide the desired pore structure—for example, the voids in each layer may fully or partially overlap the voids in an adjacent layer. In another example, a ring-shaped element (905) is used to build a porous sintered structure (907). The non-spherical elements can also be square-shaped, rectangular-shaped, octagon-shaped, etc.—other closed-loop shapes that are open-ended to permit through flow. These elements may have any wall thickness and height as necessary to form the desired structure. In addition to the open-ended closed-loop elements, elongated elements may be placed in an ordered fashion to build-up the porous structures. FIG. 9b shows two examples: elongated kinked element 909 is used to build up a mesh-like structure, a portion of which is shown at 911 and elongated wavy element 913 is used to build up mesh-like structure, a portion of which is shown at 915. The elongated elements may be of any depth and thickness as needed to obtain the desired structure. The porous sintered structure of ordered elements may resemble a honeycomb, a mesh, or a net. In certain embodiments, the beds may resemble single or multiple layer structured packings used in distillation columns, including Flexi Pac®, Flexiramic®, Gempak®, Intalox®, Max-Pak®, etc. It should be noted that hexagon, ring, elongated, etc. elements described above may also be used to make randomly assembled porous structures.

Differently shaped elements may be used to form a porous structure. Size distribution is typically fairly narrow, though bi- or multi-modal distributions or graded distributions may be used to form structures. Structure 917 of FIG. 9c, for example, is a bimodal structure having two regions 921 and 923, with distinct element size distributions. Region 921 is formed from larger elements and has larger pores while region 923 has smaller elements and pores. Multi-modal structures may be used, e.g., for efficient filtration of flowing media. The small-pore-size area provides a maximum size cutoff for contaminants in the filtered media, and may resemble a mesh, web, honeycomb, perforated sheet, expanded metal sheet, foam, packed bed, etc. As in FIG. 9c, in many embodiments it is desirable for smaller pores to be used in only a small portion of the total media volume to minimize pressure drop in the media. In some applications it is desirable for the smaller pores to be monodisperse in size. It can also be desirable for the large pores to be more tortuous than the small pores.

Structure 919 of FIG. 9c is a graded porous structure. While in many cases, it is undesirable to have a broad size distribution because smaller elements occupy voids between larger elements, thereby reducing porosity, by arranging or building up the structure properly, a graded pore structure can be obtained. Element and pore size transitions from large to small in structure 919. This may be useful, e.g., for a filtration device. In another embodiment, pore structure may transition from highly tortuous to less tortuous.

### Fabricating and Arranging Elements

The elements are capable of being sintered together and may be made out of any appropriate material, including sinterable metal, ceramic, glass, polymer, cermet, zeolite, activated carbon, etc. To be sintered, the elements are porous on at least the outer portion to allow for densification and bonding with adjacent elements. In many embodiments, fabrication of the elements includes sintering green particle compacts. The green powder compacts may be formed by any appropriate method including tape casting, extrusion, injection molding, etc. Sheets of the material may be slit and then bent to make the final shape.

The elements may include binders, plasticizers, fugitive pore formers, and other additives that may be burnt off during sintering. In a particular example, elements are fabricated with the use of fugitive pore formers to obtain the desired element shape and/or packing arrangement. For example, a stranded element may be spirally wound around a fugitive pore former body to create a coiled element after removal of the pore former.

In certain embodiments, the non-spherical elements are treated prior to being arranged into the shape of the porous structure. Treatment may include bisque firing, solvent treatment, ultraviolet treatment, ultrasound treatment, etc. The elements may be treated to improve handling, strength, etc.

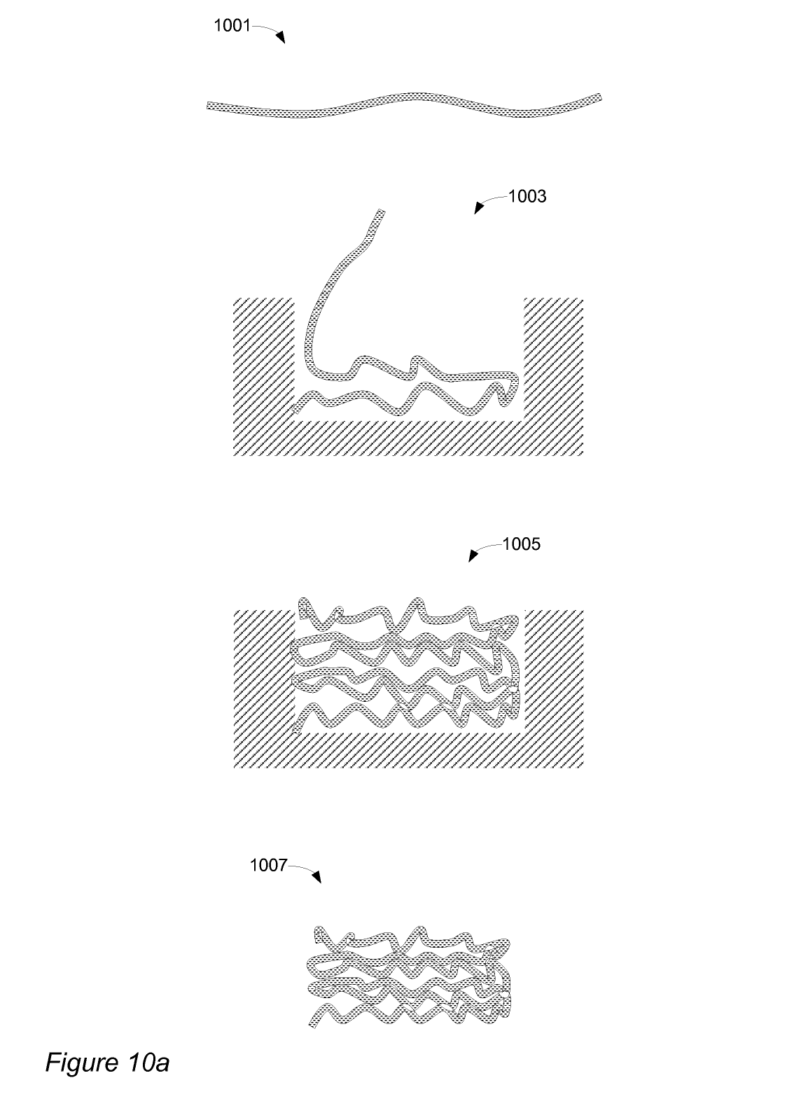

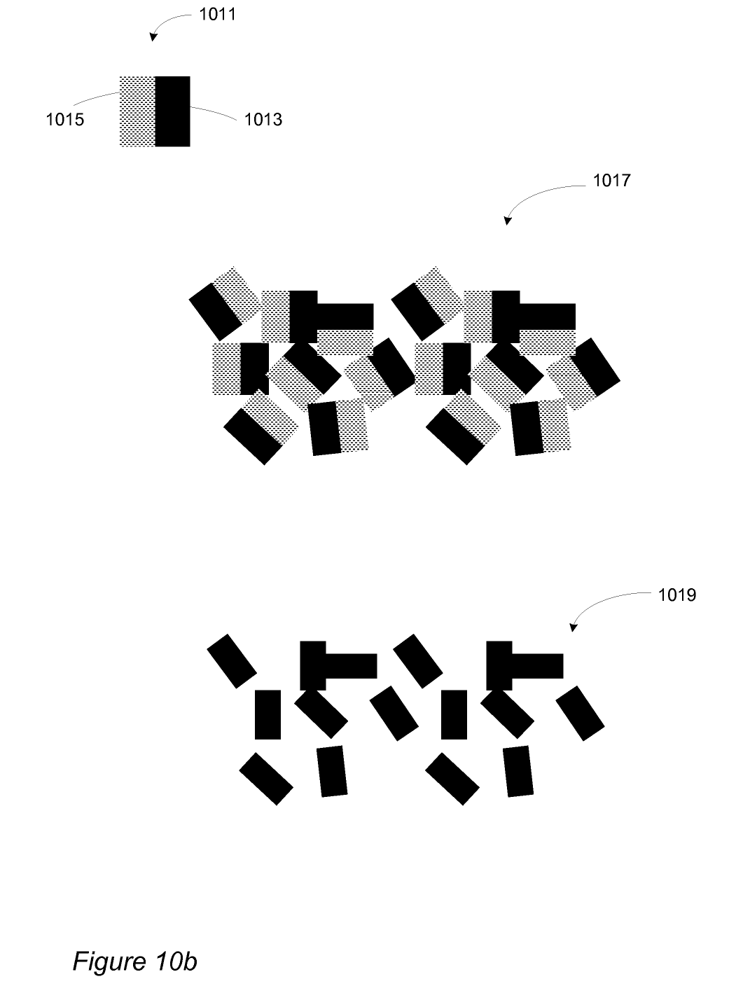

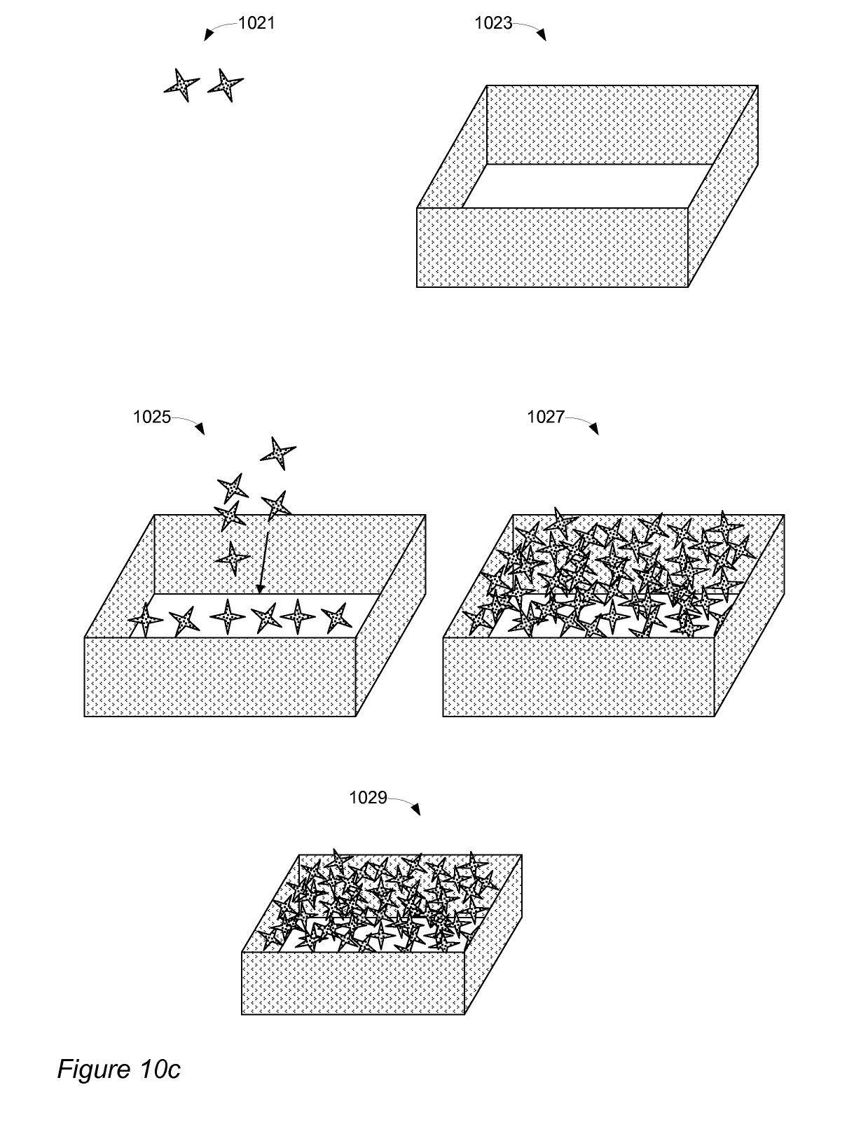

Arrangement of the elements in the die or mold may occur by any appropriate method. Randomly oriented elements may be dumped by a hopper or conveyor, shaken, injected, gravity fed, projectile sprayed or extruded into the die or mold. Elongated elements for example may be extruded directly into a desired arrangement. The packed strands may then be sintered together to form the porous structure. Elongated elements such as strands may be bent or coiled during placement into a die or mold. FIG. 10a shows one example in which elongated element 1001 is fed into a die (1003) to fit the die and build up the desired structure. Multiple strands are fed to assemble the structure (1005). The sintered structure is shown at 1007. In certain embodiments, the elements are arranged without use of a die or mold. In another example, green woven sheet elements are placed one on top of the other to arrange the elements. The green woven sheets are then sintered together to form the porous structure. Ordered elements may be placed in the die or mold. In certain embodiments, elements may be fed into the die or mold and then shaken until a desired degree of order or arrangement is obtained.

Packing density depends on the element shape, and to an extent, the method of packing. As discussed above, certain element shapes have very low random packing densities (Raschig® rings, etc.). If the random packing density of an element is too high or low, semi-random or ordered packing methods may be employed to obtain the desired packing density. Brick shaped elements, for example, may be packed very tightly (as in a brick wall), or very loosely (as in a T-shape).

In certain embodiments, fugitive pore formers are used to facilitate obtaining a desired packing arrangement or density. The elements are fabricated with the pore formers and arranged to form the desired structure. The pore formers are then removed. FIG. 10b shows an example of this process using brick-shaped elements. A composite brick-shaped element/fugitive pore former is shown at 1011. The composite includes the brick-shaped element 1013, which in many embodiments is a green powder compact at this stage, and the fugitive pore former 1015. Element 1013 is one of the building blocks of the porous sintered structure. Fugitive pore former 1015 does not form part of the final sintered structure, but is present during the building up of the structure (1017). As a result, the green powder compact elements pack more loosely than they would without the pore former 1015. The fugitive pore former is removed, e.g., during a sintering or a pre-sintering treatment. The packing density of the sintered porous structure 1019 is lower than would be obtained by randomly packing brick-shaped elements together without the fugitive pore former. At least some of the green powder compact should remain exposed to contact other elements during the arrangement of the porous structure. All or a fraction of the elements may be fabricated with fugitive pore former. In addition to creating additional void space when removed, the fugitive pore former may be added in such a manner to influence the shape and orientation of the pores.

It should be noted that the presence of the fugitive pore former as shown in FIG. 10b is quite different than from that as used in conventional porous sintered structures. In conventional porous sintered structures, the fugitive pore former is necessary to create virtually all of the interconnected porosity. This creates manufacturing difficulties as discussed above. As an additive to the non-spherical elements, pore former increases the final void space, but at a much smaller scale—for example, the fugitive pore former may create fifty percent or less of the total connected void space in the final structure. Most of void space is created by the arrangement of the non-spherical elements. Handling and removing the pore former is significantly less difficult than in conventional schemes in which the pore former is a high volume fraction of the green structure.

Forming multimodal or graded structures (such as discussed above with respect to FIG. 9c) may require particular packing methods. For example, in certain embodiments the elements may be provided to the die or mold in size order, e.g., by placing or sifting. Shaking may be necessary to separate elements in size order. In certain embodiments, one portion of the structure is built up by an ordered method while another portion is built up by random packing.

The porous structure may contain reinforcing members, such as bars, wires, webs, plates, sheets, etc. The elements may be filled around the reinforcing members, or the reinforcing members may be placed or added as the structure is built up. For example, the elements may be filled into an array of bars, similar to reinforced concrete, or an array of sheets similar to a torsion box. The bars and sheets remain part of the porous structure. The porous structure may be bound or contained in a wall or housing made of a similar material as the elements. FIG. 10c shows an example of such a process. Shaped elements and the wall are prepared in operations 1021 and 1023. The elements and the wall can be made of a similar material, so that upon sintering the shrinkage of the wall will match that of the elements. The elements and the wall can be made of different materials as desired. The elements are then arranged to be in contact with the wall as desired (1025). In the example shown in FIG. 10c, the wall is an open box that surrounds the elements. For a thin film structure, such a wall contacts the porous structure on the four minor faces of the thin film. In other embodiments, the wall may contact the structure on a single or multiple faces, or in any other arrangement as necessary. In one example, the wall contacts the structure on a major face of thin film, e.g., as a floor. After the structure is built up, the elements and wall are optionally joined together (1027) and then sintered together. The result is a porous structure bonded to or contained in a housing (1029).

The wall may be porous or dense and may be shaped as a ring, tube, box, etc. Such a wall may lend strength to the porous structure, contain the flowing media that passes through, improve handling, or provide a dense edge for bonding or sealing to an additional frame or housing. In the case of an electrochemical device application, the wall may function as a current collector.

### Joining and Sintering Elements Together

The elements and/or additional layers may contain one or more additives that enable the joining operation. For example, a powder compact element may contain a polymer that is cured or thermoset during the joining step. Additional material may also be added to enhance bonding between the repeat units. For example, a slurry, paint, etc may be applied to the points where the elements contact each other. The material may be applied at just the contact points, or more uniformly as by a washcoat, soaking in slurry, etc. Once assembled, the structure is optionally treated prior to sintering. Treatment may include bisque firing, treatment with a solvent, exposure to ultraviolet radiation, etc.

Sintering involves heating the assembled structure to a temperature below the melting point to bond the elements together. During sintering, material is transported to inter-element necks to build a strong bond. The driving force for sintering is a decrease in the surface free energy of the elements being sintered. The source of the material may be at the element surface, or from within the elements. Stronger bonds and higher densification are obtained from elements from which material can be transported from the element center. In many embodiments, high surface area particles such as powder compacts are used to make the elements. Small particles may also be added to the green structure at inter-element contact points to drive sintering.

Each element is bonded to the neighboring elements in the assembled structure. Shrinkage occurs as the structure is densified as well. Temperature depends on the material used. In many embodiments, the shaped elements are green powder compacts that are sintered simultaneously as the elements are sintered together. The porous structure is fired to remove binders, pore formers and other additives and sintered to create a strong, porous part. The elements may sinter to near or full density, providing a strong porous body. The elements may also remain porous after sintering, providing high surface area and a multi-modal pore structure. Pore formers and binders may also be removed by other means such as melting or dissolving in a liquid.

After sintering, the interior and/or exterior surfaces of porous structures can be modified by adding a coating. The coating may be porous or dense. It may be desirable to add a coating in order to improve the physical, chemical, or mechanical properties of the structure. Some examples include addition of a coating that: is catalytic, enabling chemical or electrochemical reaction; modifies the wetting of the flowing media on the surface of the porous structure; chemically or physically removes contaminants from the flowing media; and provides a thermal barrier between the flowing media and porous structure.

### Applications

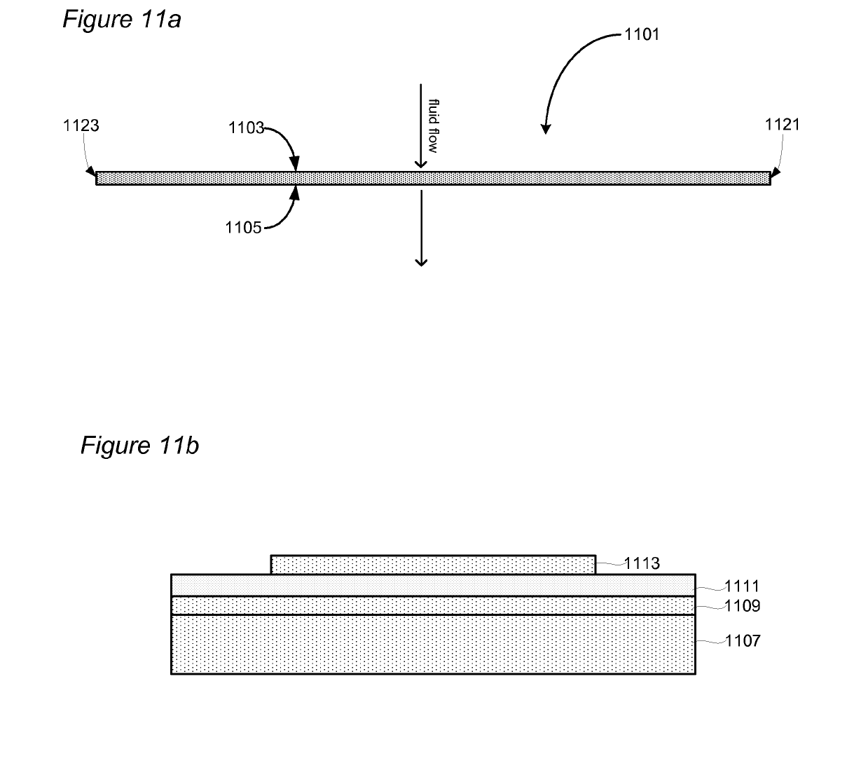

The porous structures may be used in applications in which the transfer of a fluid from one side of a porous medium to the other is desired. Applications include, but are not limited to, electrochemical devices, filtration, chromatography and flow control devices. In many embodiments, the porous structure is a thin planar sheet. FIG. 11a shows a cross-section of a thin planar porous structure 1101. The sheet has two major faces, 1101 and 1103 and two minor faces, 1121 and 1123. The dimensions of the major faces are much larger, i.e., on the order of at least 10 and up to millions of times larger, than the minor faces. Fluid flow is from one major face to the other. The connected porosity of the porous structure defines the fluid flow paths. Depending on the porous structure, the flow paths can range from straight to tortuous.

In a particular embodiment, the porous structure is a porous support for a planar solid state electrochemical device. Solid-state electrochemical devices are normally cells that include two porous electrodes, the anode and the cathode, and a dense solid electrolyte membrane disposed between the electrodes. The porous support structure described herein generally supports one or more of these layers. FIG. 11b shows one implementation of a multilayer electrochemical device that uses a porous sintered support structure. The figure shows a porous electrode layer 1113 on a dense electrolyte layer 1111 on a porous electrode layer 1109 on a porous substrate 1107. Electrode 1109 may be either the anode or the cathode; electrode 1113 is the other. In another embodiment (not shown) in which the porous sintered substrate acts as an electrode, the dense electrolyte layer contacts on the porous sintered substrate/electrode. The porous sintered substrate may be bonded to an interconnect. Typical thicknesses for a support structure range from about 50 μm-2 mm.

For a solid oxide fuel cell, hydrogen-containing fuel is provided at the anode and air is provided at the cathode. Oxygen ions (O²⁻) formed at the electrode/electrolyte interface migrate through the electrolyte and react with the hydrogen at the fuel electrode/electrolyte interface to form water, thereby releasing electrical energy that is collected by an interconnect/current collector. The same structure may be operated in reverse as an electrochemical pump by applying a potential across two electrodes. Ions formed from gas (e.g., oxygen ions from air) at the cathode will migrate through the electrolyte (which is selected for its conductivity of ions of a desired pure gas) to produce pure gas (e.g., oxygen) at the anode. If the electrolyte is a proton conducting thin film instead of an oxygen ion conductor, the device could be used to separate hydrogen from a feed gas containing hydrogen mixed with other impurities, for instance resulting from the steam reformation of methane (CH₄+H₂O→3H₂+CO). Protons (hydrogen ions) formed from the H₂/CO mixture at one electrode/thin film interface migrate across the electrolyte driven by a potential applied across the electrodes to produce high purity hydrogen at the other electrode. Thus the device may operate as a gas generator/purifier.

The solid oxide electrochemical devices described above have a thin, dense film of electrolyte in contact with a porous electrode and/or porous mechanical support. The support material is typically a cermet, metal or alloy. In certain embodiments such a structure is fabricated by sintering an electrolyte film to a porous body made of non-spherical elements.

In certain embodiments, prior to sintering the porous support structure, the green porous structure is coated with a thin electrolyte or membrane layer. The electrolyte/membrane material may be prepared as a suspension of the green powder material in a liquid media, such as water or isopropanol, and may be applied to the surface of the substrate layer by a variety of methods, e.g., aerosol spray, dip coating, electrophoretic deposition, vacuum infiltration, and tape casting. At this stage, both the porous support structure and the electrolyte membrane material are green. The assembly is fired at a temperature sufficient to sinter the substrate and densify the electrolyte. The fired bilayer shrinks as the materials sinter. In certain embodiments, a thin electrode layer may be added to the support prior to applying the electrolyte coating. One consideration with this method is that in coating the green support structure, it is useful to have the ceramic material bridge the gap between the unsintered elements of the porous structure. In certain embodiments, a graded or multi-modal pore structure (such as shown in FIG. 9c), may be used to obtain uniform coating of the electrolyte by placing the smaller elements at the surface to be coated. Because the pores are smaller at this surface, the powder or suspension is able to bridge the gap between elements. This applies to any application in which the porous structure is coated with a material.

In another embodiment, a bed of non-spherical elements is put into contact with an electrolyte or electrode layer. Upon sintering, the bed bonds to the electrolyte or electrode layer, providing mechanical support. The electrolyte and electrode layers are preferably produced using low-cost methods such as tape casting, aerosol deposition, dip-coating etc. One or both of the electrolyte and electrode layers is preferably free-standing. Thus these layers can be placed on a surface followed by loading on the non-spherical elements, or the layers may alternatively be placed on a prefabricated porous bed. Examples of porous structures appropriate to use in accordance with this embodiment is shown in FIGS. 9a at 903 and 907. A sheet of electrode or electrolyte material is contacted by a bed of non-spherical elements. The elements are placed in an ordered fashion, and may be placed as a single layer or multiple layers. Thus the continuous sheets are contacted by a bed that provides ordered structural support and also large areas of access to the sheet, for instance to allow passage of electrochemical reactants. Because the porous structure is built up on the electrolyte layer in this embodiment, there is no difficulty with the electrolyte coating bridging the gap between the elements.

Another application in which the porous sintered structures may be used is in mixture separation, including filtration and chromatography. In filtration, the filter is contacted with a fluid-solid mixture. Generally, the porous structure is designed to allow passage of the fluid while trapping or retaining the solid. The porous structures may be used for molten metal filtration, water filtration, air filtration, etc. Molten metal filters are often made of ceramic materials or high temperature glass (e.g. quartz), which can withstand high temperatures and processing conditions required to filter out impurities from molten metals. Honeycomb or mesh filters that provide non-tortuous paths for fluid flow (such as described above with respect to FIG. 9a) may be particularly useful for metal filtration. Air filters are often made of glass or zeolite materials, and water filters of activated carbon. In many embodiments, the filters are graded porous structures, such as shown above in FIG. 9c. Pore size may gradually increase from top to bottom, for example, with the top regions physically removes particles and lower regions providing support and efficient drainage.

The porous structure may be formed directly on a slurry chamber or other structure from which the fluid to be filtered will originate. Likewise, the porous structure may be formed directly on the container or structure that will contain the filtrate. In other embodiments, the filter may be formed as a free standing structure. The porous structures may also be formed within a housing or frame as described above with respect to FIG. 10c for easy placement in a filtration assembly. Similarly, the filters may be formed as removable cartridges.

### EXAMPLES

The following examples are intended to illustrate various aspects of the invention, and do not limit the invention in any way.

### Porous Stainless Steel Bed

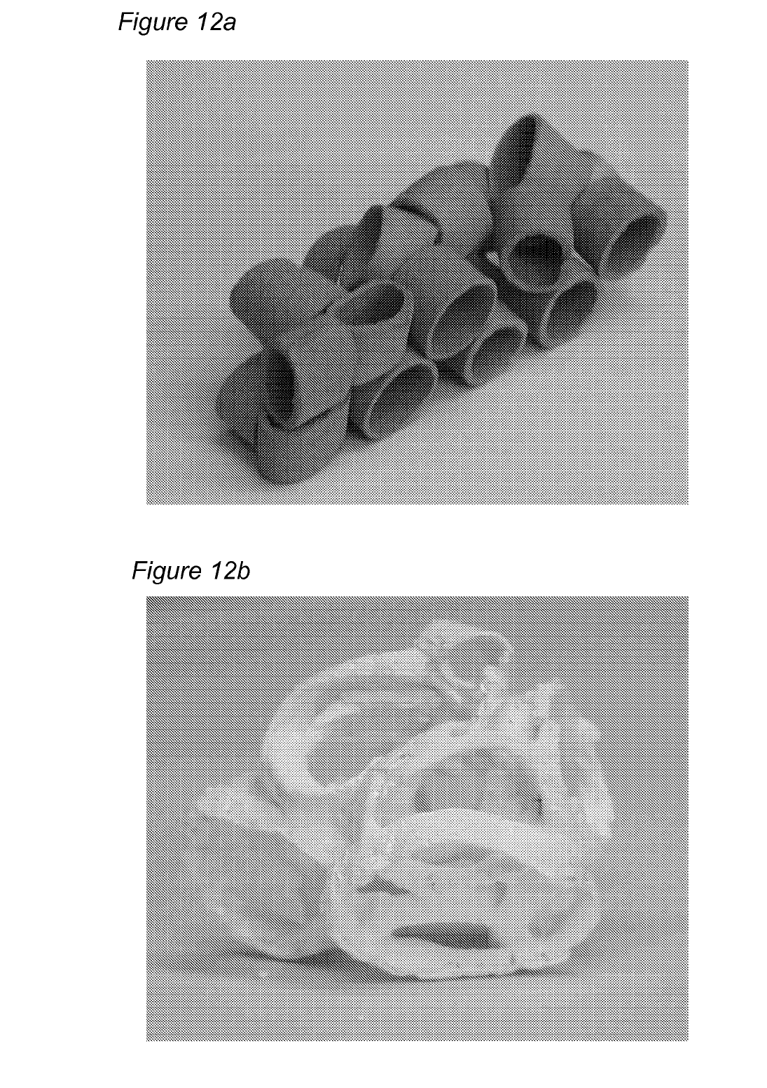

A sintered free-standing bed of stainless steel cylindrical sleeve elements was produced. The packed bed was made as follows. Stainless steel 434 (38-45 micrometer particle size) powder was mixed with acrylic binder (15 wt % in water), polyethylene glycol 6000, and polymethylmethacrylate pore former spheres (53-76 micrometer diameter) in the weight ratio 10:3:0.5:1.5. The mixture was heated and dried, grinded and sieved to <150 micrometers. The resulting powder was formed into tubes by cold isostatic pressing at 20 kpsi. The tubes were cut to form sleeves approximately 1 cm in diameter and 1 cm tall. These sleeves were debinded in air at 525° C. and then bisque fired for 2 hours at 1000° C. in reducing atmosphere (4% H₂ in Argon). The sleeves were then piled into an alumina boat and sintered at 1300° C. for 4 hours in reducing atmosphere. A free-standing monolithic bed was easily removed from the boat after sintering. An image of the sintered structure is provided in FIG. 12a. Note that the shape of the sleeves provides a packed bed with pore size on the order of 1 cm. The walls of the sleeves are also porous, with pore size in the range 20-100 micrometers. Note that the walls could also be made dense, by removing the pore former spheres and choosing an appropriate metal particle size and sintering temperature.

### Porous Ceramic Bed

A sintered free-standing bed comprising alumina ring elements was produced. An image is provided in FIG. 12b. The individual rings are approximately 1 cm diameter. The random packing of the bed provides very high porosity, while the multiple contact points of each ring provides good strength.

The packed bed was made as follows. A mixture of alumina powder (1 micrometer particle size) and acrylic binder (42 wt % in water) was mixed in a flat-bottomed plastic contained and allowed to dry. The resulting sheet was removed from the container and cut into strips. The strips were then made into rings by pressing the ends of a strip together by hand, allowing sufficient time for the acrylic binder in each end to stick together. The rings were then piled successively on top of each other at various orientations. A small amount of wet alumina powder/acrylic binder mixture was added to the contact points between each new ring and the bed of previously-placed rings. This created strong bonds between the ring units during sintering. The assembly was sintered in air for 4 h at 1400° C. In this example the ring walls of the sintered structure are porous, though dense ring walls also can be produced by adjusting the alumina-to-acrylic ratio, alumina particle size, sintering temperature, etc.

### CONCLUSION

Although the foregoing invention has been described in some detail for purposes of clarity of understanding, those skilled in the art will appreciate that various adaptations and modifications of the just-described preferred embodiments can be configured without departing from the scope and spirit of the invention. Moreover, the described processing distribution and classification engine features of the present invention may be implemented together or independently. Therefore, the described embodiments should be taken as illustrative and not restrictive, and the invention should not be limited to the details given herein but should be defined by the following claims and their full scope of equivalents.

1-50. (canceled)

51. A method of fabricating a porous network, said method comprising:
providing a plurality of green non-spherical elements, wherein each non-spherical element comprises particles;
arranging the non-spherical elements in a desired network shape to form a green porous body; and
simultaneously sintering the particles together to form sintered non-spherical elements and sintering the non-spherical elements together to form the porous network.

52. The method of claim 51 wherein the non-spherical elements are joined together prior to being sintered together.

53. The method of claim 52 wherein the joining the non-spherical elements comprises at least one of: bisque firing the non-spherical elements, compressing the non-spherical elements, washcoating or slurry-coating the elements with binder or particles, and exposing the non-spherical elements to at least one of heat, a solvent, light, and ultrasound waves.

54. The method of claim 52 wherein non-spherical elements comprise a polymer and the joining the non-spherical elements comprises curing or thermosetting the polymer.

55. The method of claim 51 further comprising applying an additive to the arranged non-spherical elements to enhance bonding between the non-spherical elements.

56. The method of claim 51 wherein arranging the non-spherical elements comprises inserting the non-spherical elements into a die or mold by one of injection, gravity feed, projectile spray and extrusion.

57. The method of claim 51 wherein arranging the non-spherical elements comprises randomly packing the non-spherical elements in a die or mold.

58. The method of claim 51 wherein the non-spherical elements comprise at least one of a binder, a plasticizer and a fugitive pore former.

59. The method of claim 51 further comprising forming the non-spherical elements by at least one of tape casting powder, injection molding powder, and extruding powder.

60. The method of claim 51 wherein the non-spherical elements are porous.

61. A porous network comprising a plurality of sintered-together non-spherical elements, wherein each non-spherical element comprises a plurality of sintered-together particles.

62. The porous network of claim 61,
wherein said porous network has first and second major surfaces;
said porous network defining a plurality of flow paths from the first major surface to the second major surface;
wherein the size of said elements ranges from 5 microns to 5 centimeters, and wherein the network has a connected porosity of at least 30%.

63. A solid state electrochemical device comprising the porous network of claim 61, said porous network having a connected porosity of at least 30%; a solid electrolyte; and a porous second electrode.

64. A fluid filtration device comprising the porous network of claim 61, wherein the size of said elements is from about 5 microns to 5 centimeters and said porous network has a connected porosity of at least 30%.

65. The network of claim 61 wherein the non-spherical elements comprise a material selected from metal, ceramic, cermet, polymer, glass, activated carbon and zeolite.

66. The network of claim 61 wherein the non-spherical elements are selected from the group consisting of stellated-shaped elements, linear, bent or coiled strand elements, spiral elements, brick-shaped elements, ring-shaped elements, tubular elements, torroidal elements, saddle-shaped elements, disks, sheets, woven elements and jack-shaped elements.

67. The network of claim 61 wherein the non-spherical elements are porous.

68. The network of claim 61 wherein the porous network is substantially planar.

69. The network of claim 61 wherein the porous network has a graded pore structure.

70. A method of fabricating a porous network, said method comprising:
providing a plurality of green non-spherical elements;
arranging the plurality of non-spherical elements in a plane having first and second major faces to form a green porous body, wherein the non-spherical elements each comprises particles;
sintering the particles to form sintered non-spherical elements; and
sintering the plurality of non-spherical elements together to fabricate the porous network;
wherein the particles and the non-spherical elements are simultaneously sintered.
